(19) United States
(12) Patent Application Publication
(10) Pub. No.: US 2025/0150857 A1
(43) Pub. Date: May 8, 2025

(54) DYNAMIC UPLINK (UL) WAVEFORM SWITCHING BETEEN DFT-S-OFDM AND CP-OFDM

(71) Applicant: Parsa Wireless Communications LLC, Stamford, CT (US)

(72) Inventor: Reza Kalbasi, San Diego, CA (US)

(73) Assignee: Parsa Wireless Communications LLC, Stamford, CT (US)

(21) Appl. No.: 18/935,758

(22) Filed: Nov. 4, 2024

Related U.S. Application Data
(60) Provisional application No. 63/595,808, filed on Nov. 3, 2023.

(51) Int. Cl. H04W 24/02; H04L 1/00; H04L 27/26; H04W 52/36

(52) U.S. Cl. CPC H04W 24/02; H04L 1/0003; H04L 27/2636; H04W 52/365; H04W 52/367

(57) ABSTRACT

Apparatus and methods for uplink (UL) waveform Dynamic Switching (DS) in a wireless communication system are disclosed. During operation, a gNB initiates the method by sending a configuration to a user equipment (UE) indicating the use of a first waveform for uplink (UL) transmission. Subsequently, the gNB receives data from the UE transmitted using the first waveform for a predetermined duration and a first report that includes the physical characteristics of the first waveform. The gNB then transmits another configuration to the UE, specifying the use of a second waveform for UL transmission. The gNB then receives data from the UE transmitted using the second waveform for the predetermined duration with a second report detailing the physical characteristics of the second waveform. The gNB then sends a message to the UE, instructing it to utilize the first waveform or the second waveform for UL transmission.

This application claims priority under 35 USC § 119(e) from U.S. Provisional Patent Application No. 63/595,808, filed on Nov. 3, 2023 (“the provisional application”); the content of the provisional patent application is incorporated herein by reference.

### BACKGROUND OF THE INVENTION

The present invention is directed to 5G, which is the 5^{th} generation mobile network. It is a new global wireless standard after 1G, 2G, 3G, and 4G networks. 5G enables networks designed to connect machines, objects and devices.

The invention is more specifically directed to a method of optimizing wireless communication in a cellular network, for example, where a user equipment (UE) receives from a base station (BS) a configuration indicating a waveforms associated with uplink (UL) transmission, transmits and receives messages from the BS indicating to whether to employ one of the waveforms for UL transmission.

### SUMMARY OF THE INVENTION

In an embodiment, the invention provides a method optimizing wireless communication in a cellular network, performed by a user equipment (UE). The method comprises receiving, from a base station (BS), a configuration indicating a first waveform associated with uplink (UL) transmission; transmitting, to the BS, data employing the first waveform for a predetermined duration; reporting, to the BS, physical characteristics of the first waveform; receiving, from the BS, another configuration indicating a second waveform associated with the uplink (UL) transmission; transmitting, to the BS, the data employing the second waveform for the predetermined duration; reporting, to the BS, the physical characteristics of the second waveform; and receiving a message, from the BS, indicating to whether to employ the first waveform or the second waveform for the UL transmission.

The the first waveform may include a discrete Fourier transform spread orthogonal frequency division multiplexing (DFT-S-OFDM) waveform configured for a single transmission layer transmission and the second waveform may include cyclic prefix frequency division multiplexing (CP-OFDM) waveform configured for a single transmission layer or multiple transmission layers. The physical characteristics of the first waveform and of the second waveform include power headroom (PH), maximum transmit power (Pmax), maximum permissible exposure (MPE), signal-to-noise ratio (SNR), transmit power control (TPC) and acknowledge/negative acknowledge (ACK/NCK). The message includes the frequency domain resource allocation, and modulation and coding scheme (MCS) of the first or the second waveform.

In an embodiment, the method may include determining a preferred waveform between the first waveform and the second waveform based on the physical characteristics of the first waveform and the physical characteristics of the second waveform; and reporting the preferred waveform to the base station (BS). The method also may include receiving an indication, from the base station (BS), to switch from the first waveform to the second waveform; or receiving an indication, from the BS, to switch from the second waveform to the first waveform.

In an embodiment, invention presents a method for optimizing wireless communication in a cellular network, performed by a base station (BS), including transmitting, to a user equipment (UE), a configuration indicating a first waveform associated with uplink (UL) transmission; receiving, from the UE, data on the first waveform for a predetermined duration; receiving a first report, from the UE, including physical characteristics of the first waveform; transmitting, to the UE, another configuration indicating a second waveform associated with the uplink (UL) transmission; receiving, from the UE, the data employing the second waveform for the predetermined duration; receiving a second report, from the UE, including the physical characteristics of the second waveform; and transmitting a message to the UE indicating to whether to employ the first waveform or the second waveform for the UL transmission.

In the method, the first waveform includes a discrete Fourier transform spread orthogonal frequency division multiplexing (DFT-S-OFDM) waveform configured for a single transmission layer transmission; and the second waveform includes cyclic prefix frequency division multiplexing (CP-OFDM) waveform configured for a single transmission layer or multiple transmission layers. The first report may include power headroom (PH), maximum transmit power (Pmax), maximum permissible exposure (MPE), signal-to-noise ratio (SNR), transmit power control (TPC) and ACK/NCK of the first waveform; and the second report may include power headroom (PH), maximum transmit power (Pmax), maximum permissible exposure (MPE), signal-to-noise ratio (SNR), transmit power control (TPC), and ACK/NCK of the second waveform.

The method may further include determining the first waveform or the second waveform for the uplink (UL) transmission based on the received first report and the second report and alternatively, the determining may further include considering frequency domain resource allocation, and modulation and coding scheme (MCS) of the first or the second waveform. The determining might include computing the uplink (UL) throughput employing the first waveform; computing the UL throughput employing the second waveform; comparing the computed UL throughput of the first waveform and the second waveform; and indicating, to the UE, to employ the first waveform whether computed throughput of the first waveform is greater than the computed throughput of the second waveform; or indicating, to the UE, to employ the second waveform whether computed throughput of the second waveform is greater or equal than the computed throughput of the second waveform.

For that matter, the determining may be based on comparing at least one of physical characteristic of the first waveform and the second waveform, and wherein the physical characteristics include: power headroom (PH), maximum transmit power (Pmax), maximum permissible exposure (MPE), signal-to-noise ratio (SNR), transmit power control (TPC) and ACK/NCK. And the method may further include determining to switch from the first waveform to the second waveform, or to switch from the second waveform to the first waveform; transmitting an indication, to the user equipment (UE), to switch from the first waveform to the second waveform; or transmitting an indication, to the UE, to switch from the second waveform to the first waveform. The switching can includes considering frequency domain resource allocation, and modulation and coding scheme (MCS) of the first or the second waveform.

In the method, the determining can include comparing one or more physical characteristics of the first waveform with associated thresholds; or comparing one or more physical characteristics of the second waveform with associated threshold. The physical characteristics of the first waveform and the second waveform may include power headroom (PH), maximum transmit power (Pmax), maximum permissible exposure (MPE), signal-to-noise ratio (SNR), transmit power control (TPC), and ACK/NCK. The base station (BS) may determine to switch from the first waveform to the second waveform if power headroom (PH) of the first waveform falls below a threshold; or determine to switch from the second waveform to the first waveform if the PH of the second waveform falls below a threshold.

In an embodiment, the invention presents a A base station (BS) with a transceiver configured to: transmit, to a user equipment (UE), a configuration indicating a first waveform associated with uplink (UL) transmission; receive, from the UE, data on the first waveform for a predetermined duration; receive a first report, from the UE, including physical characteristics of the first waveform; transmit to the UE, another configuration indicating a second waveform associated with the uplink (UL) transmission; receive, from the UE, the data employing the second waveform for the predetermined duration; receive a second report, from the UE, including the physical characteristics of the second waveform; and transmit a message to the UE, indicating whether to employ the first waveform or the second waveform for the UL transmission. Preferably, the inventive BS includes a processor configured to: determining the first waveform or the second waveform for the uplink (UL) transmission based on the received first report and the second report.

### BRIEF DESCRIPTION OF THE DRAWINGS

FIG. 1 shows an example of a system of mobile communications according to some aspects of some of various exemplary embodiments of the present disclosure.

FIG. 2A and FIG. 2B show examples of radio protocol stacks for user plane and control plane, respectively, according to some aspects of some of various exemplary embodiments of the present disclosure.

FIG. 3A, FIG. 3B and FIG. 3C show example mappings between logical channels and transport channels in downlink, uplink and sidelink, respectively, according to some aspects of some of various exemplary embodiments of the present disclosure.

FIG. 4A, FIG. 4B and FIG. 4C show example mappings between transport channels and physical channels in downlink, uplink and sidelink, respectively, according to some aspects of some of various exemplary embodiments of the present disclosure.

FIG. 5A, FIG. 5B, FIG. 5C and FIG. 5D show examples of radio protocol stacks for NR sidelink communication according to some aspects of some of various exemplary embodiments of the present disclosure.

FIG. 6 shows example physical signals in downlink, uplink and sidelink according to some aspects of some of various exemplary embodiments of the present disclosure.

FIG. 7 shows examples of Radio Resource Control (RRC) states and transitioning between different RRC states according to some aspects of some of various exemplary embodiments of the present disclosure.

FIG. 8 shows example frame structure and physical resources according to some aspects of some of various exemplary embodiments of the present disclosure.

FIG. 9 shows example component carrier configurations in different carrier aggregation scenarios according to some aspects of some of various exemplary embodiments of the present disclosure.

FIG. 10 shows example bandwidth part configuration and switching according to some aspects of some of various exemplary embodiments of the present disclosure.

FIG. 11 shows example of a wireless system capable of uplink waveform dynamic switching (DS) according to some aspects of some of various exemplary embodiments of the present disclosure.

FIG. 12A, 12B are example diagrams illustrating switching between CP-OFDM to DFT-S-OFDM and vice versa respectively according to some aspects of some of various exemplary embodiments of the present disclosure.

FIG. 13 shows example components of a user equipment and a base station for transmission and/or reception according to some aspects of some of various exemplary embodiments of the present disclosure.

FIG. 14 shows an example of a method performed by a UE to perform dynamic waveform switching according to some aspects of some of various exemplary embodiments of the present disclosure.

FIG. 15 shows an example of a method performed by a BS to perform dynamic waveform switching according to some aspects of some of various exemplary embodiments of the present disclosure.

### DETAILED DESCRIPTION

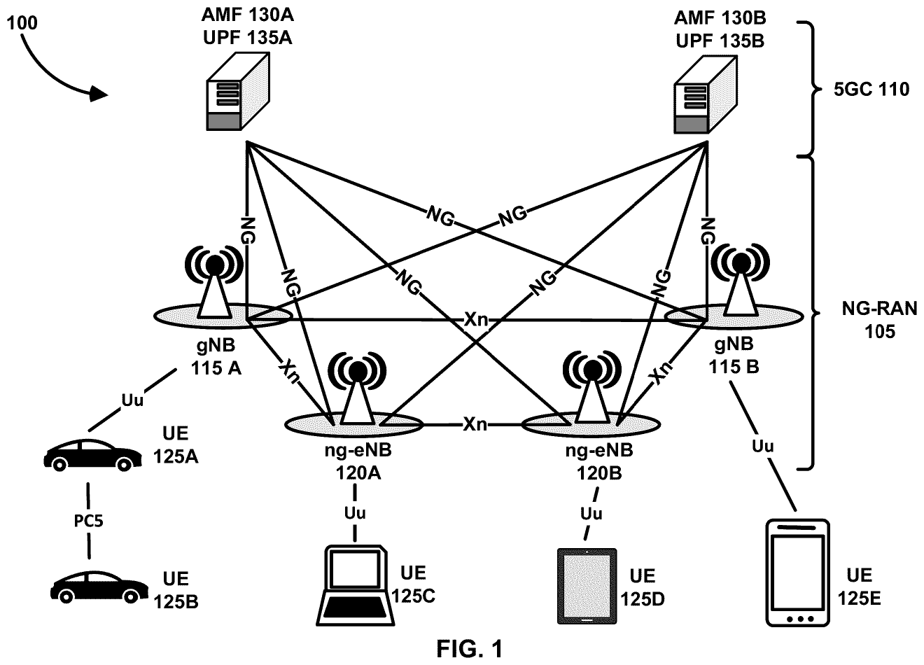

FIG. 1 shows an example of a system of mobile communications 100 according to some aspects of some of various exemplary embodiments of the present disclosure. The system of mobile communication 100 may be operated by a wireless communications system operator such as a Mobile Network Operator (MNO), a private network operator, a Multiple System Operator (MSO), an Internet of Things (IOT) network operator, etc., and may offer services such as voice, data (e.g., wireless Internet access), messaging, vehicular communications services such as Vehicle to Everything (V2X) communications services, safety services, mission critical service, services in residential, commercial or industrial settings such as IoT, industrial IOT (IIOT), etc.

The system of mobile communications 100 may enable various types of applications with different requirements in terms of latency, reliability, throughput, etc. Example supported applications include enhanced Mobile Broadband (eMBB), Ultra-Reliable Low-Latency Communications (URLLC), and massive Machine Type Communications (mMTC). eMBB may support stable connections with high peak data rates, as well as moderate rates for cell-edge users. URLLC may support applications with strict requirements in terms of latency and reliability and moderate requirements in terms of data rate. Example mMTC application includes a network of a massive number of IoT devices, which are only sporadically active and send small data payloads.

The system of mobile communications 100 may include a Radio Access Network (RAN) portion and a core network portion. The example shown in FIG. 1 illustrates a Next Generation RAN (NG-RAN) 105 and a 5G Core Network (5GC) 110 as examples of the RAN and core network, respectively. Other examples of RAN and core network may be implemented without departing from the scope of this disclosure. Other examples of RAN include Evolved Universal Terrestrial Radio Access Network (EUTRAN), Universal Terrestrial Radio Access Network (UTRAN), etc. Other examples of core network include Evolved Packet Core (EPC), UMTS Core Network (UCN), etc. The RAN implements Radio Access Technology (RAT) and resides between User Equipments (UEs) 125 and the core network. Examples of such RATs include New Radio (NR), Long Term Evolution (LTE) also known as Evolved Universal Terrestrial Radio Access (EUTRA), Universal Mobile Telecommunication System (UMTS), etc. The RAT of the example system of mobile communications 100 may be NR. The core network resides between the RAN and one or more external networks (e.g., data networks) and is responsible for functions such as mobility management, authentication, session management, setting up bearers and application of different Quality of Services (QoSs). The functional layer between the UE 125 and the RAN (e.g., the NG-RAN 105) may be referred to as Access Stratum (AS) and the functional layer between the UE 125 and the core network (e.g., the 5GC 110) may be referred to as Non-access Stratum (NAS).

The UEs 125 may include wireless transmission and reception means for communications with one or more nodes in the RAN, one or more relay nodes, or one or more other UEs, etc. Examples of UEs include, but are not limited to, smartphones, tablets, laptops, computers, wireless transmission and/or reception units in a vehicle, V2X or Vehicle to Vehicle (V2V) devices, wireless sensors, IoT devices, IIOT devices, etc. Other names may be used for UEs such as a Mobile Station (MS), terminal equipment, terminal node, client device, mobile device, etc.

The RAN may include nodes (e.g., base stations) for communications with the UEs. For example, the NG-RAN 105 of the system of mobile communications 100 may comprise nodes for communications with the UEs 125. Different names for the RAN nodes may be used, for example depending on the RAT used for the RAN. A RAN node may be referred to as Node B (NB) in a RAN that uses the UMTS RAT. A RAN node may be referred to as an evolved Node B (eNB) in a RAN that uses LTE/EUTRA RAT. For the illustrative example of the system of mobile communications 100 in FIG. 1, the nodes of an NG-RAN 105 may be either a next generation Node B (gNB) 115 or a next generation evolved Node B (ng-eNB) 120. In this specification, the terms base station, RAN node, gNB and ng-eNB may be used interchangeably. The gNB 115 may provide NR user plane and control plane protocol terminations towards the UE 125. The ng-eNB 120 may provide E-UTRA user plane and control plane protocol terminations towards the UE 125. An interface between the gNB 115 and the UE 125 or between the ng-eNB 120 and the UE 125 may be referred to as a Uu interface. The Uu interface may be established with a user plane protocol stack and a control plane protocol stack. For a Uu interface, the direction from the base station (e.g., the gNB 115 or the ng-eNB 120) to the UE 125 may be referred to as downlink and the direction from the UE 125 to the base station (e.g., gNB 115 or ng-eNB 120) may be referred to as uplink.

The gNBs 115 and ng-eNBs 120 may be interconnected with each other by means of an Xn interface. The Xn interface may comprise an Xn User plane (Xn-U) interface and an Xn Control plane (Xn-C) interface. The transport network layer of the Xn-U interface may be built on Internet Protocol (IP) transport and GPRS Tunneling Protocol (GTP) may be used on top of User Datagram Protocol (UDP)/IP to carry the user plane protocol data units (PDUs). Xn-U may provide non-guaranteed delivery of user plane PDUs and may support data forwarding and flow control. The transport network layer of the Xn-C interface may be built on Stream Control Transport Protocol (SCTP) on top of IP. The application layer signaling protocol may be referred to as XnAP (Xn Application Protocol). The SCTP layer may provide the guaranteed delivery of application layer messages. In the transport IP layer, point-to-point transmission may be used to deliver the signaling PDUs. The Xn-C interface may support Xn interface management, UE mobility management, including context transfer and RAN paging, and dual connectivity.

The gNBs 115 and ng-eNBs 120 may also be connected to the 5GC 110 by means of the NG interfaces, more specifically to an Access and Mobility Management Function (AMF) 130 of the 5GC 110 by means of the NG-C interface and to a User Plane Function (UPF) 135 of the 5GC 110 by means of the NG-U interface. The transport network layer of the NG-U interface may be built on IP transport and GTP protocol may be used on top of UDP/IP to carry the user plane PDUs between the NG-RAN node (e.g., gNB 115 or ng-eNB 120 and the UPF 135. NG-U may provide non-guaranteed delivery of user plane PDUs between the NG-RAN node and the UPF. The transport network layer of the NG-C interface may be built on IP transport. For the reliable transport of signaling messages, SCTP may be added on top of IP. The application layer signaling protocol may be referred to as NGAP (NG Application Protocol). The SCTP layer may provide guaranteed delivery of application layer messages. In the transport, IP layer point-to-point transmission may be used to deliver the signaling PDUs. The NG-C interface may provide the following functions: NG interface management; UE context management; UE mobility management; transport of NAS messages; paging; PDU Session Management; configuration transfer; and warning message transmission.

The gNB 115 or the ng-eNB 120 may host one or more of the following functions: Radio Resource Management functions such as Radio Bearer Control, Radio Admission Control, Connection Mobility Control, Dynamic allocation of resources to UEs in both uplink and downlink (e.g., scheduling); IP and Ethernet header compression, encryption and integrity protection of data; Selection of an AMF at UE attachment when no routing to an AMF can be determined from the information provided by the UE; Routing of User Plane data towards UPF(s); Routing of Control Plane information towards AMF; Connection setup and release; Scheduling and transmission of paging messages; Scheduling and transmission of system broadcast information (e.g., originated from the AMF); Measurement and measurement reporting configuration for mobility and scheduling; Transport level packet marking in the uplink; Session Management; Support of Network Slicing; QoS Flow management and mapping to data radio bearers; Support of UEs in RRC Inactive state; Distribution function for NAS messages; Radio access network sharing; Dual Connectivity; Tight interworking between NR and E-UTRA; and Maintaining security and radio configuration for User Plane 5G system (5GS) Cellular IoT (CIoT) Optimization.

The AMF 130 may host one or more of the following functions: NAS signaling termination; NAS signaling security; AS Security control; Inter CN node signaling for mobility between 3GPP access networks; Idle mode UE Reachability (including control and execution of paging retransmission); Registration Area management; Support of intra-system and inter-system mobility; Access Authentication; Access Authorization including check of roaming rights; Mobility management control (subscription and policies); Support of Network Slicing; Session Management Function (SMF) selection; Selection of 5GS CIoT optimizations.

The UPF 135 may host one or more of the following functions: Anchor point for Intra-/Inter-RAT mobility (when applicable); External PDU session point of interconnect to Data Network; Packet routing & forwarding; Packet inspection and User plane part of Policy rule enforcement; Traffic usage reporting; Uplink classifier to support routing traffic flows to a data network; Branching point to support multi-homed PDU session; QoS handling for user plane, e.g. packet filtering, gating, UL/DL rate enforcement; Uplink Traffic verification (Service Data Flow (SDF) to QoS flow mapping); Downlink packet buffering and downlink data notification triggering.

As shown in FIG. 1, the NG-RAN 105 may support the PC5 interface between two UEs 125 (e.g., UE 125A and UE125B). In the PC5 interface, the direction of communications between two UEs (e.g., from UE 125A to UE 125B or vice versa) may be referred to as sidelink. Sidelink transmission and reception over the PC5 interface may be supported when the UE 125 is inside NG-RAN 105 coverage, irrespective of which RRC state the UE is in, and when the UE 125 is outside NG-RAN 105 coverage. Support of V2X services via the PC5 interface may be provided by NR sidelink communication and/or V2X sidelink communication.

PC5-S signaling may be used for unicast link establishment with Direct Communication Request/Accept message. A UE may self-assign its source Layer-2 ID for the PC5 unicast link, for example based on the V2X service type. During unicast link establishment procedure, the UE may send its source Layer-2 ID for the PC5 unicast link to the peer UE, e.g., the UE for which a destination ID has been received from the upper layers. A pair of source Layer-2 ID, and destination Layer-2 ID may uniquely identify a unicast link. The receiving UE may verify that the said destination ID belongs to it and may accept the Unicast link establishment request from the source UE. During the PC5 unicast link establishment procedure, a PC5-RRC procedure on the Access Stratum may be invoked for the purpose of UE sidelink context establishment as well as for AS layer configurations, capability exchange etc. PC5-RRC signaling may enable exchanging UE capabilities and AS layer configurations such as Sidelink Radio Bearer configurations between pair of UEs for which a PC5 unicast link is established.

NR sidelink communication may support one of three types of transmission modes (e.g., Unicast transmission, Groupcast transmission, and Broadcast transmission) for a pair of a Source Layer-2 ID and a Destination Layer-2 ID in the AS. The Unicast transmission mode may be characterized by: Support of one PC5-RRC connection between peer UEs for the pair; Transmission and reception of control information and user traffic between peer UEs in sidelink; Support of sidelink HARQ feedback; Support of sidelink transmit power control; Support of RLC Acknowledged Mode (AM); and Detection of radio link failure for the PC5-RRC connection. The Groupcast transmission may be characterized by: Transmission and reception of user traffic among UEs belonging to a group in sidelink; and Support of sidelink HARQ feedback. The Broadcast transmission may be characterized by: Transmission and reception of user traffic among UEs in sidelink.

A Source Layer-2 ID, a Destination Layer-2 ID and a PC5 Link Identifier may be used for NR sidelink communication. The Source Layer-2 ID may be a link-layer identity that identifies a device or a group of devices that are recipients of sidelink communication frames. The Destination Layer-2 ID may be a link-layer identity that identifies a device that originates sidelink communication frames. In some examples, the Source Layer-2 ID, and the Destination Layer-2 ID may be assigned by a management function in the Core Network. The Source Layer-2 ID may identify the sender of the data in NR sidelink communication. The Source Layer-2 ID may be 24 bits long and may be split in the MAC layer into two bit strings: One bit string may be the LSB part (8 bits) of Source Layer-2 ID and forwarded to physical layer of the sender. This may identify the source of the intended data in sidelink control information and may be used for filtering of packets at the physical layer of the receiver; and the Second bit string may be the MSB part (16 bits) of the Source Layer-2 ID and may be carried within the Medium Access Control (MAC) header. This may be used for filtering packets at the MAC layer of the receiver. The Destination Layer-2 ID may identify the target of the data in NR sidelink communication. For NR sidelink communication, the Destination Layer-2 ID may be 24 bits long and may be split in the MAC layer into two bit strings: One bit string may be the LSB part (16 bits) of Destination Layer-2 ID and forwarded to physical layer of the sender. This may identify the target of the intended data in sidelink control information and may be used for filtering packets at the physical layer of the receiver; and the Second bit string may be the MSB part (8 bits) of the Destination Layer-2 ID and may be carried within the MAC header. This may be used for filtering packets at the MAC layer of the receiver. The PC5 Link Identifier may uniquely identify the PC5 unicast link in a UE for the lifetime of the PC5 unicast link. The PC5 Link Identifier may be used to indicate the PC5 unicast link whose sidelink Radio Link failure (RLF) declaration was made and PC5-RRC connection was released.

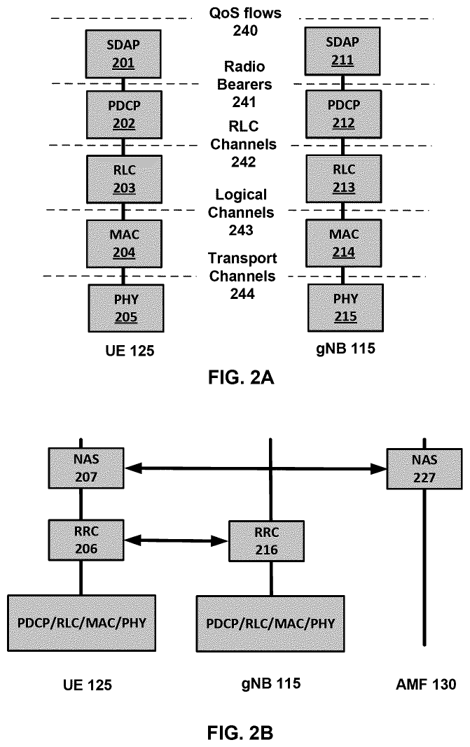

FIG. 2A and FIG. 2B show examples of radio protocol stacks for user plane and control plane, respectively, according to some aspects of some of various exemplary embodiments of the present disclosure. As shown in FIG. 2A, the protocol stack for the user plane of the Uu interface (between the UE 125 and the gNB 115) includes Service Data Adaptation Protocol (SDAP) 201 and SDAP 211, Packet Data Convergence Protocol (PDCP) 202 and PDCP 212, Radio Link Control (RLC) 203 and RLC 213, MAC 204 and MAC 214 sublayers of layer 2 and Physical (PHY) 205 and PHY 215 layer (layer 1 also referred to as L1).

The PHY 205 and PHY 215 offer transport channels 244 to the MAC 204 and MAC 214 sublayer. The MAC 204 and MAC 214 sublayer offer logical channels 243 to the RLC 203 and RLC 213 sublayer. The RLC 203 and RLC 213 sublayer offer RLC channels 242 to the PDCP 202 and PCP 212 sublayer. The PDCP 202 and PDCP 212 sublayer offer radio bearers 241 to the SDAP 201 and SDAP 211 sublayer. Radio bearers may be categorized into two groups: Data Radio Bearers (DRBs) for user plane data and Signaling Radio Bearers (SRBs) for control plane data. The SDAP 201 and SDAP 211 sublayer offers QoS flows 240 to 5GC.

The main services and functions of the MAC 204 or MAC 214 sublayer include: mapping between logical channels and transport channels; Multiplexing/demultiplexing of MAC Service Data Units (SDUs) belonging to one or different logical channels into/from Transport Blocks (TB) delivered to/from the physical layer on transport channels; Scheduling information reporting; Error correction through Hybrid Automatic Repeat Request (HARQ) (one HARQ entity per cell in case of carrier aggregation (CA)); Priority handling between UEs by means of dynamic scheduling; Priority handling between logical channels of one UE by means of Logical Channel Prioritization (LCP); Priority handling between overlapping resources of one UE; and Padding. A single MAC entity may support multiple numerologies, transmission timings and cells. Mapping restrictions in logical channel prioritization control which numerology(ies), cell(s), and transmission timing(s) a logical channel may use.

The HARQ functionality may ensure delivery between peer entities at Layer 1. A single HARQ process may support one TB when the physical layer is not configured for downlink/uplink spatial multiplexing, and when the physical layer is configured for downlink/uplink spatial multiplexing, a single HARQ process may support one or multiple TBs.

The RLC 203 or RLC 213 sublayer may support three transmission modes: Transparent Mode (TM); Unacknowledged Mode (UM); and Acknowledged Mode (AM). The RLC configuration may be per logical channel with no dependency on numerologies and/or transmission durations, and Automatic Repeat Request (ARQ) may operate on any of the numerologies and/or transmission durations the logical channel is configured with.

The main services and functions of the RLC 203 or RLC 213 sublayer depend on the transmission mode (e.g., TM, UM or AM) and may include: Transfer of upper layer PDUs; Sequence numbering independent of the one in PDCP (UM and AM); Error Correction through ARQ (AM only); Segmentation (AM and UM) and re-segmentation (AM only) of RLC SDUs; Reassembly of SDU (AM and UM); Duplicate Detection (AM only); RLC SDU discard (AM and UM); RLC re-establishment; and Protocol error detection (AM only).

The automatic repeat request within the RLC 203 or RLC 213 sublayer may have the following characteristics: ARQ retransmits RLC SDUs or RLC SDU segments based on RLC status reports; Polling for RLC status report may be used when needed by RLC; RLC receiver may also trigger RLC status report after detecting a missing RLC SDU or RLC SDU segment.

The main services and functions of the PDCP 202 or PDCP 212 sublayer may include: Transfer of data (user plane or control plane); Maintenance of PDCP Sequence Numbers (SNs); Header compression and decompression using the Robust Header Compression (ROHC) protocol; Header compression and decompression using EHC protocol; Ciphering and deciphering; Integrity protection and integrity verification; Timer based SDU discard; Routing for split bearers; Duplication; Reordering and in-order delivery; Out-of-order delivery; and Duplicate discarding.

The main services and functions of SDAP 201 or SDAP 211 include: Mapping between a QoS flow and a data radio bearer; and Marking QoS Flow ID (QFI) in both downlink and uplink packets. A single protocol entity of SDAP may be configured for each individual PDU session.

As shown in FIG. 2B, the protocol stack of the control plane of the Uu interface (between the UE 125 and the gNB 115) includes PHY layer (layer 1), and MAC, RLC and PDCP sublayers of layer 2 as described above and in addition, the RRC 206 sublayer and RRC 216 sublayer. The main services and functions of the RRC 206 sublayer and the RRC 216 sublayer over the Uu interface include: Broadcast of System Information related to AS and NAS; Paging initiated by 5GC or NG-RAN; Establishment, maintenance and release of an RRC connection between the UE and NG-RAN (including Addition, modification and release of carrier aggregation; and Addition, modification and release of Dual Connectivity in NR or between E-UTRA and NR); Security functions including key management; Establishment, configuration, maintenance and release of SRBs and DRBs; Mobility functions (including Handover and context transfer; UE cell selection and reselection and control of cell selection and reselection; and Inter-RAT mobility); QoS management functions; UE measurement reporting and control of the reporting; Detection of and recovery from radio link failure; and NAS message transfer to/from NAS from/to UE. The NAS 207 and NAS 227 layer is a control protocol (terminated in AMF on the network side) that performs the functions such as authentication, mobility management, security control, etc.

The sidelink specific services and functions of the RRC sublayer over the Uu interface include: Configuration of sidelink resource allocation via system information or dedicated signaling; Reporting of UE sidelink information; Measurement configuration and reporting related to sidelink; and Reporting of UE assistance information for SL traffic pattern(s).

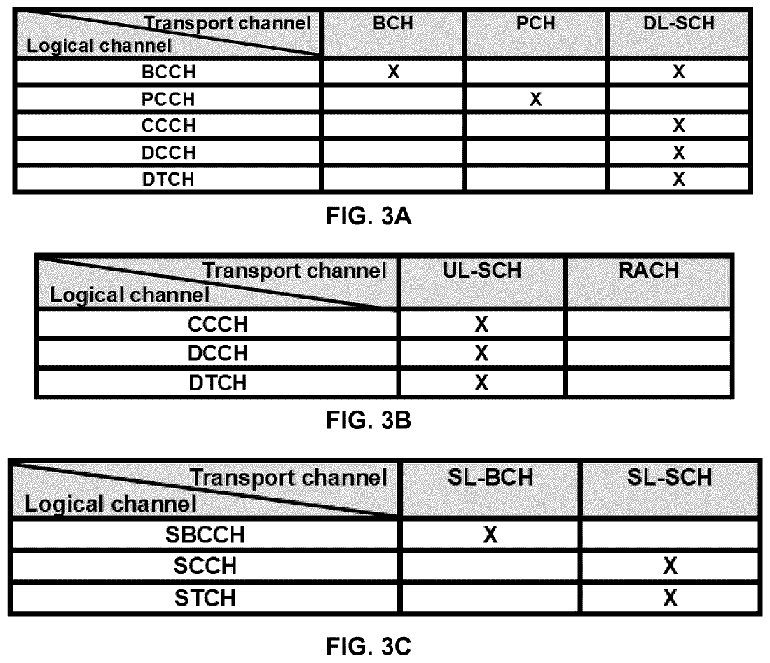

FIG. 3A, FIG. 3B and FIG. 3C show example mappings between logical channels and transport channels in downlink, uplink and sidelink, respectively, according to some aspects of some of various exemplary embodiments of the present disclosure. Different kinds of data transfer services may be offered by MAC. Each logical channel type may be defined by what type of information is transferred. Logical channels may be classified into two groups: Control Channels and Traffic Channels. Control channels may be used for the transfer of control plane information only. The Broadcast Control Channel (BCCH) is a downlink channel for broadcasting system control information. The Paging Control Channel (PCCH) is a downlink channel that carries paging messages. The Common Control Channel (CCCH) is a channel for transmitting control information between the UEs and network. This channel may be used for UEs having no RRC connection with the network. The Dedicated Control Channel (DCCH) is a point-to-point bi-directional channel that transmits dedicated control information between a UE and the network and may be used by UEs having an RRC connection. Traffic channels may be used for the transfer of user plane information only. The Dedicated Traffic Channel (DTCH) is a point-to-point channel, dedicated to one UE, for the transfer of user information. A DTCH may exist in both uplink and downlink. Sidelink Control Channel (SCCH) is a sidelink channel for transmitting control information (e.g., PC5-RRC and PC5-S messages) from one UE to other UE(s). Sidelink Traffic Channel (STCH) is a sidelink channel for transmitting user information from one UE to other UE(s). Sidelink Broadcast Control Channel (SBCCH) is a sidelink channel for broadcasting sidelink system information from one UE to other UE(s).

The downlink transport channel types include Broadcast Channel (BCH), Downlink Shared Channel (DL-SCH), and Paging Channel (PCH). BCH may be characterized by: fixed, pre-defined transport format; and requirement to be broadcast in the entire coverage area of the cell, either as a single message or by beamforming different BCH instances. The DL-SCH may be characterized by: support for HARQ; support for dynamic link adaptation by varying the modulation, coding and transmit power; possibility to be broadcast in the entire cell; possibility to use beamforming; support for both dynamic and semi-static resource allocation; and the support for UE Discontinuous Reception (DRX) to enable UE power saving. The DL-SCH may be characterized by: support for HARQ; support for dynamic link adaptation by varying the modulation, coding and transmit power; possibility to be broadcast in the entire cell; possibility to use beamforming; support for both dynamic and semi-static resource allocation; support for UE discontinuous reception (DRX) to enable UE power saving. The PCH may be characterized by: support for UE discontinuous reception (DRX) to enable UE power saving (DRX cycle is indicated by the network to the UE); requirement to be broadcast in the entire coverage area of the cell, either as a single message or by beamforming different BCH instances; mapped to physical resources which can be used dynamically also for traffic/other control channels.

In downlink, the following connections between logical channels and transport channels may exist: BCCH may be mapped to BCH; BCCH may be mapped to DL-SCH; PCCH may be mapped to PCH; CCCH may be mapped to DL-SCH; DCCH may be mapped to DL-SCH; and DTCH may be mapped to DL-SCH.

The uplink transport channel types include Uplink Shared Channel (UL-SCH) and Random Access Channel(s) (RACH). The UL-SCH may be characterized by possibility to use beamforming; support for dynamic link adaptation by varying the transmit power and potentially modulation and coding; support for HARQ; support for both dynamic and semi-static resource allocation. The RACH may be characterized by limited control information, and collision risk.

In Uplink, the following connections between logical channels and transport channels may exist: CCCH may be mapped to UL-SCH; DCCH may be mapped to UL-SCH; and DTCH may be mapped to UL-SCH.

The sidelink transport channel types include: Sidelink broadcast channel (SL-BCH) and Sidelink shared channel (SL-SCH). The SL-BCH may be characterized by pre-defined transport format. The SL-SCH may be characterized by support for unicast transmission, groupcast transmission and broadcast transmission; support for both UE autonomous resource selection and scheduled resource allocation by NG-RAN; support for both dynamic and semi-static resource allocation when UE is allocated resources by the NG-RAN; support for HARQ; and support for dynamic link adaptation by varying the transmit power, modulation and coding.

In the sidelink, the following connections between logical channels and transport channels may exist: SCCH may be mapped to SL-SCH; STCH may be mapped to SL-SCH; and SBCCH may be mapped to SL-BCH.

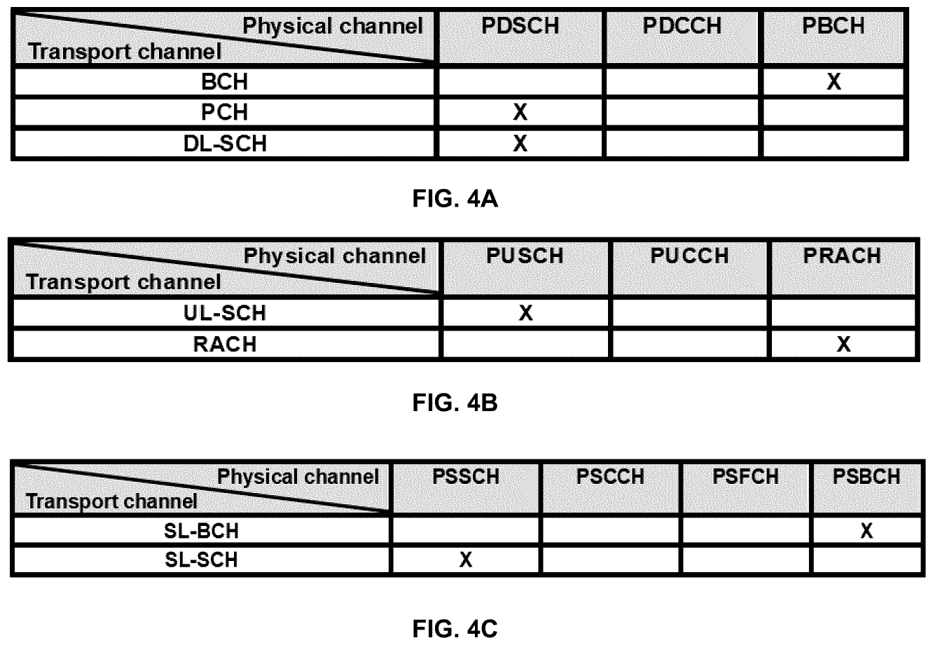

FIG. 4A, FIG. 4B and FIG. 4C show example mappings between transport channels and physical channels in downlink, uplink and sidelink, respectively, according to some aspects of some of various exemplary embodiments of the present disclosure. The physical channels in downlink include Physical Downlink Shared Channel (PDSCH), Physical Downlink Control Channel (PDCCH) and Physical Broadcast Channel (PBCH). The PCH and DL-SCH transport channels are mapped to the PDSCH. The BCH transport channel is mapped to the PBCH. A transport channel is not mapped to the PDCCH, but Downlink Control Information (DCI) is transmitted via the PDCCH.

The physical channels in the uplink include Physical Uplink Shared Channel (PUSCH), Physical Uplink Control Channel (PUCCH) and Physical Random Access Channel (PRACH). The UL-SCH transport channel may be mapped to the PUSCH, and the RACH transport channel may be mapped to the PRACH. A transport channel is not mapped to the PUCCH, but Uplink Control Information (UCI) is transmitted via the PUCCH.

The physical channels in the sidelink include Physical Sidelink Shared Channel (PSSCH), Physical Sidelink Control Channel (PSCCH), Physical Sidelink Feedback Channel (PSFCH) and Physical Sidelink Broadcast Channel (PSBCH). The Physical Sidelink Control Channel (PSCCH) may indicate resource and other transmission parameters used by a UE for PSSCH. The Physical Sidelink Shared Channel (PSSCH) may transmit the TBs of data themselves, and control information for HARQ procedures and CSI feedback triggers, etc. At least 6 OFDM symbols within a slot may be used for PSSCH transmission. Physical Sidelink Feedback Channel (PSFCH) may carry the HARQ feedback over the sidelink from a UE which is an intended recipient of a PSSCH transmission to the UE which performed the transmission. PSFCH sequence may be transmitted in one PRB repeated over two OFDM symbols near the end of the sidelink resource in a slot. The SL-SCH transport channel may be mapped to the PSSCH. The SL-BCH may be mapped to PSBCH. No transport channel is mapped to the PSFCH, but Sidelink Feedback Control Information (SFCI) may be mapped to the PSFCH. No transport channel is mapped to PSCCH, but Sidelink Control Information (SCI) may be mapped to PSCCH.

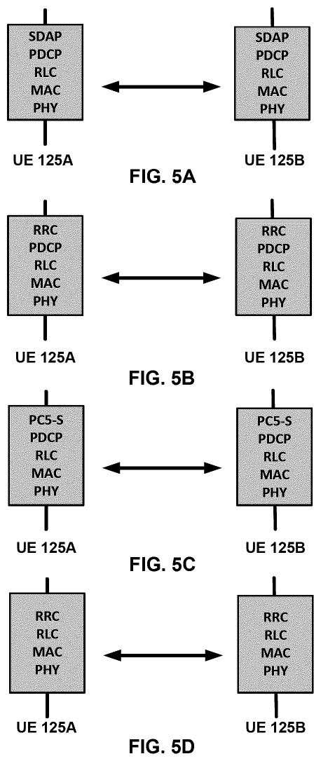

FIG. 5A, FIG. 5B, FIG. 5C and FIG. 5D show examples of radio protocol stacks for NR sidelink communication according to some aspects of some of various exemplary embodiments of the present disclosure. The AS protocol stack for user plane in the PC5 interface (i.e., for STCH) may consist of SDAP, PDCP, RLC and MAC sublayers, and the physical layer. The protocol stack of user plane is shown in FIG. 5A. The AS protocol stack for SBCCH in the PC5 interface may consist of RRC, RLC, MAC sublayers, and the physical layer as shown below in FIG. 5B. For support of PC5-S protocol, PC5-S is located on top of PDCP, RLC and MAC sublayers, and the physical layer in the control plane protocol stack for SCCH for PC5-S, as shown in FIG. 5C. The AS protocol stack for the control plane for SCCH for RRC in the PC5 interface consists of RRC, PDCP, RLC and MAC sublayers, and the physical layer. The protocol stack of control plane for SCCH for RRC is shown in FIG. 5D.

The Sidelink Radio Bearers (SLRBs) may be categorized into two groups: Sidelink Data Radio Bearers (SL DRB) for user plane data and Sidelink Signaling Radio Bearers (SL SRB) for control plane data. Separate SL SRBs using different SCCHs may be configured for PC5-RRC and PC5-S signaling, respectively.

The MAC sublayer may provide the following services and functions over the PC5 interface: Radio resource selection; Packet filtering; Priority handling between uplink and sidelink transmissions for a given UE; and Sidelink CSI reporting. With logical channel prioritization restrictions in MAC, only sidelink logical channels belonging to the same destination may be multiplexed into a MAC PDU for every unicast, groupcast and broadcast transmission which may be associated to the destination. For packet filtering, a SL-SCH MAC header including portions of both Source Layer-2 ID and a Destination Layer-2 ID may be added to a MAC PDU. The Logical Channel Identifier (LCID) included within a MAC subheader may uniquely identify a logical channel within the scope of the Source Layer-2 ID and Destination Layer-2 ID combination.

The services and functions of the RLC sublayer may be supported for sidelink. Both RLC Unacknowledged Mode (UM) and Acknowledged Mode (AM) may be used in unicast transmission while only UM may be used in groupcast or broadcast transmission. For UM, only unidirectional transmission may be supported for groupcast and broadcast.

The services and functions of the PDCP sublayer for the Uu interface may be supported for sidelink with some restrictions: Out-of-order delivery may be supported only for unicast transmission; and Duplication may not be supported over the PC5 interface.

The SDAP sublayer may provide the following service and function over the PC5 interface: Mapping between a QoS flow and a sidelink data radio bearer. There may be one SDAP entity per destination for one of unicast, groupcast and broadcast which is associated to the destination.

The RRC sublayer may provide the following services and functions over the PC5 interface: Transfer of a PC5-RRC message between peer UEs; Maintenance and release of a PC5-RRC connection between two UEs; and Detection of sidelink radio link failure for a PC5-RRC connection based on indication from MAC or RLC. A PC5-RRC connection may be a logical connection between two UEs for a pair of Source and Destination Layer-2 IDs which may be considered to be established after a corresponding PC5 unicast link is established. There may be one-to-one correspondence between the PC5-RRC connection and the PC5 unicast link. A UE may have multiple PC5-RRC connections with one or more UEs for different pairs of Source and Destination Layer-2 IDs. Separate PC5-RRC procedures and messages may be used for a UE to transfer UE capability and sidelink configuration including SL-DRB configuration to the peer UE. Both peer UEs may exchange their own UE capability and sidelink configuration using separate bi-directional procedures in both sidelink directions.

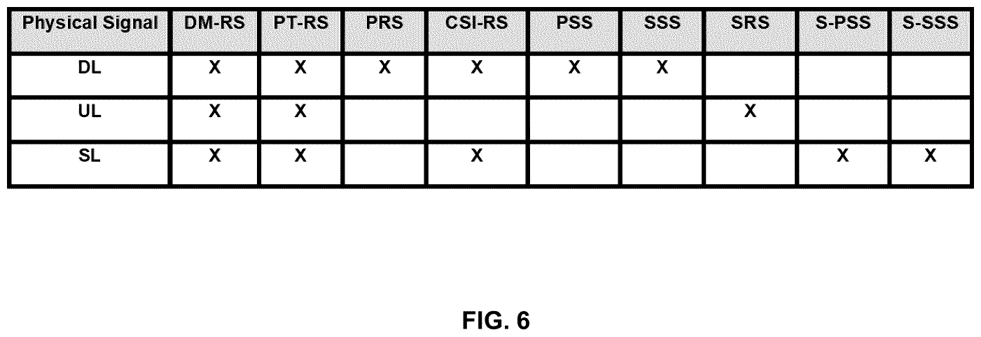

FIG. 6 shows example physical signals in downlink, uplink and sidelink according to some aspects of some of various exemplary embodiments of the present disclosure. The Demodulation Reference Signal (DM-RS) may be used in downlink, uplink and sidelink and may be used for channel estimation. DM-RS is a UE-specific reference signal and may be transmitted together with a physical channel in downlink, uplink or sidelink and may be used for channel estimation and coherent detection of the physical channel. The Phase Tracking Reference Signal (PT-RS) may be used in downlink, uplink and sidelink and may be used for tracking the phase and mitigating the performance loss due to phase noise. The PT-RS may be used mainly to estimate and minimize the effect of Common Phase Error (CPE) on system performance. Due to the phase noise properties, PT-RS signal may have a low density in the frequency domain and a high density in the time domain. PT-RS may occur in combination with DM-RS and when the network has configured PT-RS to be present. The Positioning Reference Signal (PRS) may be used in downlink for positioning using different positioning techniques. PRS may be used to measure the delays of the downlink transmissions by correlating the received signal from the base station with a local replica in the receiver. The Channel State Information Reference Signal (CSI-RS) may be used in downlink and sidelink. CSI-RS may be used for channel state estimation, Reference Signal Received Power (RSRP) measurement for mobility and beam management, time/frequency tracking for demodulation among other uses. CSI-RS may be configured UE-specifically but multiple users may share the same CSI-RS resource. The UE may determine CSI reports and transit them in the uplink to the base station using PUCCH or PUSCH. The CSI report may be carried in a sidelink MAC CE. The Primary Synchronization Signal (PSS) and the Secondary Synchronization Signal (SSS) may be used for radio fame synchronization. The PSS and SSS may be used for the cell search procedure during the initial attachment or for mobility purposes. The Sounding Reference Signal (SRS) may be used in uplink for uplink channel estimation. Similar to CSI-RS, the SRS may serve as QCL reference for other physical channels such that they can be configured and transmitted quasi-collocated with SRS. The Sidelink PSS (S-PSS) and Sidelink SSS (S-SSS) may be used in sidelink for sidelink synchronization.

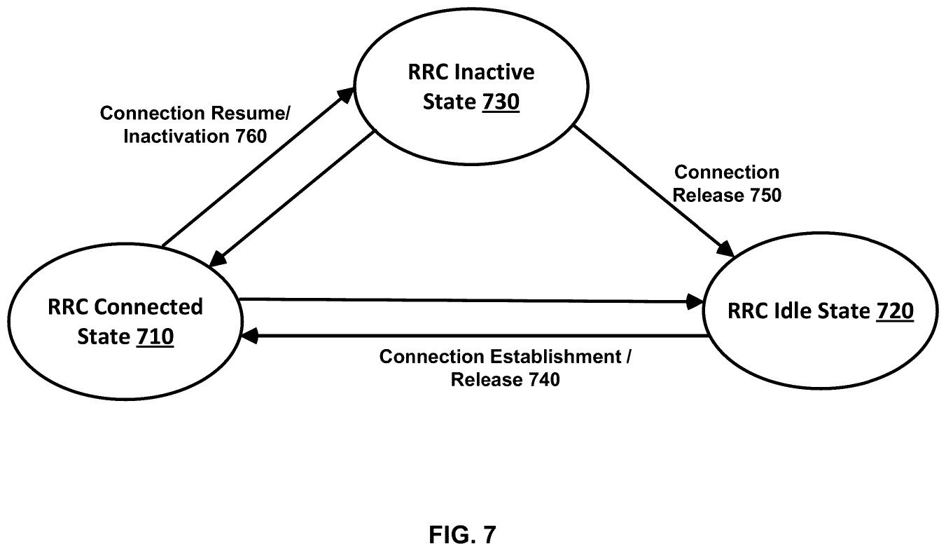

FIG. 7 shows examples of Radio Resource Control (RRC) states and transitioning between different RRC states according to some aspects of some of various exemplary embodiments of the present disclosure. A UE may be in one of three RRC states: RRC Connected State 710, RRC Idle State 720 and RRC Inactive state 730. After power up, the UE may be in RRC Idle state 720, and the UE may establish connection with the network using initial access and via an RRC connection establishment procedure to perform data transfer and/or to make/receive voice calls. Once RRC connection is established, the UE may be in RRC Connected State 710. The UE may transition from the RRC Idle state 720 to the RRC connected state 710 or from the RRC Connected State 710 to the RRC Idle state 720 using the RRC connection Establishment/Release procedures 740.

To reduce the signaling load and the latency resulting from frequent transitioning from the RRC Connected State 710 to the RRC Idle State 720 when the UE transmits frequent small data, the RRC Inactive State 730 may be used. In the RRC Inactive State 730, the AS context may be stored by both UE and gNB. This may result in faster state transition from the RRC Inactive State 730 to RRC Connected State 710. The UE may transition from the RRC Inactive State 730 to the RRC Connected State 710 or from the RRC Connected State 710 to the RRC Inactive State 730 using the RRC Connection Resume/Inactivation procedures 760. The UE may transition from the RRC Inactive State 730 to RRC Idle State 720 using an RRC Connection Release procedure 750.

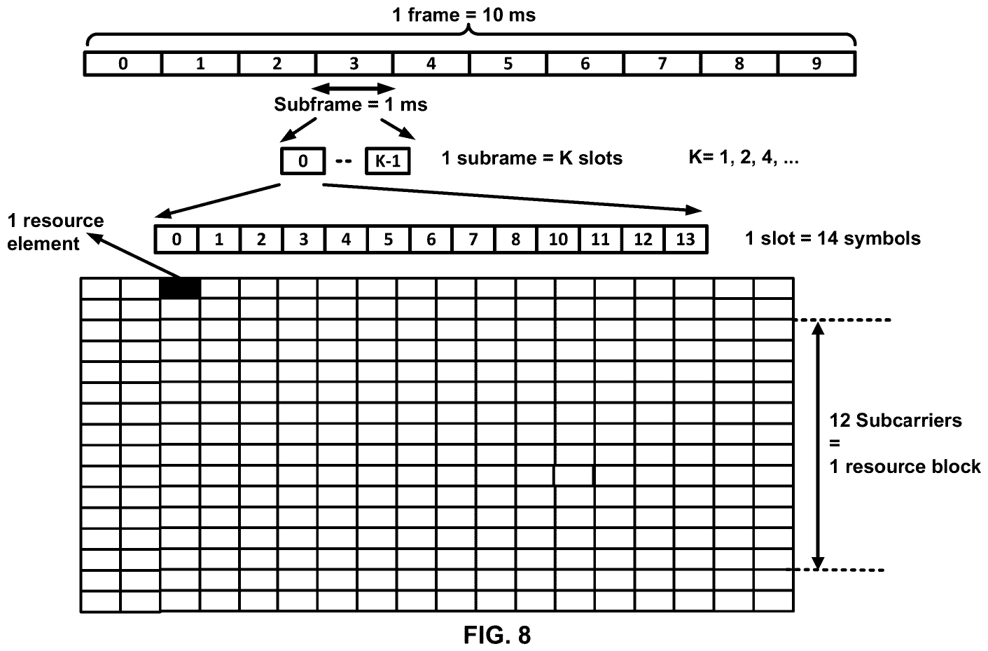

FIG. 8 shows example frame structure and physical resources according to some aspects of some of various exemplary embodiments of the present disclosure. The downlink or uplink or sidelink transmissions may be organized into frames with 10 ms duration, consisting of ten 1 ms subframes. Each subframe may consist of 1, 2, 4, . . . slots, wherein the number of slots per subframe may depend on the subcarrier spacing of the carrier on which the transmission takes place. The slot duration may be 14 symbols with Normal Cyclic Prefix (CP) and 12 symbols with Extended CP and may scale in time as a function of the used sub-carrier spacing so that there is an integer number of slots in a subframe. FIG. 8 shows a resource grid in time and frequency domain. Each element of the resource grid, comprising one symbol in time and one subcarrier in frequency, is referred to as a Resource Element (RE). A Resource Block (RB) may be defined as 12 consecutive subcarriers in the frequency domain.

In some examples and with non-slot-based scheduling, the transmission of a packet may occur over a portion of a slot, for example during 2, 4 or 7 OFDM symbols which may also be referred to as mini-slots. The mini slots may be used for low latency applications such as URLLC and operation in unlicensed bands. In some embodiments, the mini slots may also be used for fast flexible scheduling of services (e.g., pre-emption of URLLC over eMBB).

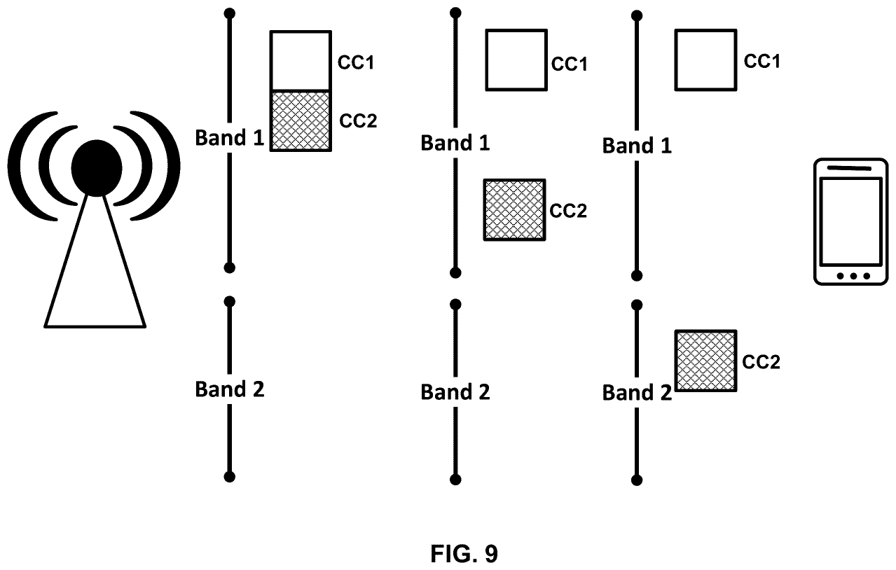

FIG. 9 shows example component carrier configurations in different carrier aggregation scenarios according to some aspects of some of various exemplary embodiments of the present disclosure. In Carrier Aggregation (CA), two or more Component Carriers (CCs) may be aggregated. A UE may simultaneously receive or transmit on one or multiple CCs depending on its capabilities. CA may be supported for both contiguous and non-contiguous CCs in the same band or on different bands as shown in FIG. 9. A gNB and the UE may communicate using a serving cell. A serving cell may be associated at least one downlink CC (e.g., may be associated only with one downlink CC or may be associated with a downlink CC and an uplink CC). A serving cell may be a Primary Cell (PCell) or a Secondary cCell (SCell).

A UE may adjust the timing of its uplink transmissions using an uplink timing control procedure. A Timing Advance (TA) may be used to adjust the uplink frame timing relative to the downlink frame timing. The gNB may determine the desired Timing Advance setting and provides that to the UE. The UE may use the provided TA to determine its uplink transmit timing relative to the UE's observed downlink receive timing.

In the RRC Connected state, the gNB may be responsible for maintaining the timing advance to keep the L1 synchronized. Serving cells having uplink to which the same timing advance applies and using the same timing reference cell are grouped in a Timing Advance Group (TAG). A TAG may contain at least one serving cell with configured uplink. The mapping of a serving cell to a TAG may be configured by RRC. For the primary TAG, the UE may use the PCell as timing reference cell, except with shared spectrum channel access where an SCell may also be used as timing reference cell in certain cases. In a secondary TAG, the UE may use any of the activated SCells of this TAG as a timing reference cell and may not change it unless necessary.

Timing advance updates may be signaled by the gNB to the UE via MAC CE commands. Such commands may restart a TAG-specific timer which may indicate whether the L1 can be synchronized or not: when the timer is running, the L1 may be considered synchronized, otherwise, the L1 may be considered non-synchronized (in which case uplink transmission may only take place on PRACH).

A UE with single timing advance capability for CA may simultaneously receive and/or transmit multiple CCs corresponding to multiple serving cells sharing the same timing advance (multiple serving cells grouped in one TAG). A UE with multiple timing advance capability for CA may simultaneously receive and/or transmit on multiple CCs corresponding to multiple serving cells with different timing advances (multiple serving cells grouped in multiple TAGs). The NG-RAN may ensure that each TAG contains at least one serving cell. A non-CA capable UE may receive on a single CC and may transmit on a single CC corresponding to one serving cell only (one serving cell in one TAG).

The multi-carrier nature of the physical layer in case of CA may be exposed to the MAC layer and one HARQ entity may be required per serving cell. When CA is configured, the UE may have one RRC connection with the network. At RRC connection establishment/re-establishment/handover, one serving cell (e.g., the PCell) may provide the NAS mobility information. Depending on UE capabilities, SCells may be configured to form together with the PCell a set of serving cells. The configured set of serving cells for a UE may consist of one PCell and one or more SCells. The reconfiguration, addition and removal of SCells may be performed by RRC.

In a dual connectivity scenario, a UE may be configured with a plurality of cells comprising a Master Cell Group (MCG) for communications with a master base station, a Secondary Cell Group (SCG) for communications with a secondary base station, and two MAC entities: one MAC entity and for the MCG for communications with the master base station and one MAC entity for the SCG for communications with the secondary base station.

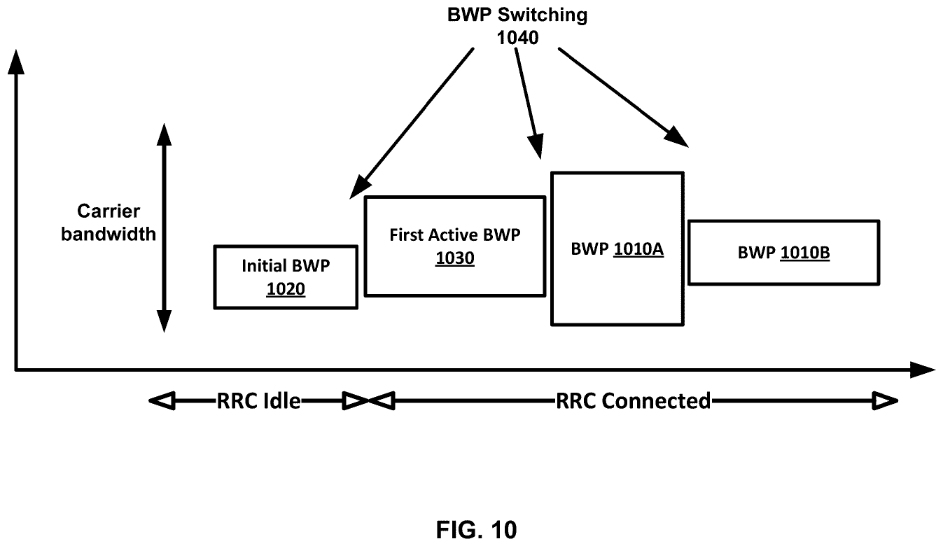

FIG. 10 shows example bandwidth part configuration and switching according to some aspects of some of various exemplary embodiments of the present disclosure. The UE may be configured with one or more Bandwidth Parts (BWPs) 1010 on a given component carrier. In some examples, one of the one or more bandwidth parts may be active at a time. The active bandwidth part may define the UE's operating bandwidth within the cell's operating bandwidth. For initial access, and until the UE's configuration in a cell is received, initial bandwidth part 1020 determined from system information may be used. With Bandwidth Adaptation (BA), for example through BWP switching 1040, the receive and transmit bandwidth of a UE may not be as large as the bandwidth of the cell and may be adjusted. For example, the width may be ordered to change (e.g., to shrink during period of low activity to save power); the location may move in the frequency domain (e.g., to increase scheduling flexibility); and the subcarrier spacing may be ordered to change (e.g., to allow different services). The first active BWP 1020 may be the active BWP upon RRC (re-) configuration for a PCell or activation of an SCell.

For a downlink BWP or uplink BWP in a set of downlink BWPs or uplink BWPs, respectively, the UE may be provided the following configuration parameters: a Subcarrier Spacing (SCS); a cyclic prefix; a common RB and a number of contiguous RBs; an index in the set of downlink BWPs or uplink BWPs by respective BWP-Id; a set of BWP-common and a set of BWP-dedicated parameters. A BWP may be associated with an OFDM numerology according to the configured subcarrier spacing and cyclic prefix for the BWP. For a serving cell, a UE may be provided by a default downlink BWP among the configured downlink BWPs. If a UE is not provided a default downlink BWP, the default downlink BWP may be the initial downlink BWP.

A downlink BWP may be associated with a BWP inactivity timer. If the BWP inactivity timer associated with the active downlink BWP expires and if the default downlink BWP is configured, the UE may perform BWP switching to the default BWP. If the BWP inactivity timer associated with the active downlink BWP expires and if the default downlink BWP is not configured, the UE may perform BWP switching to the initial downlink BWP.

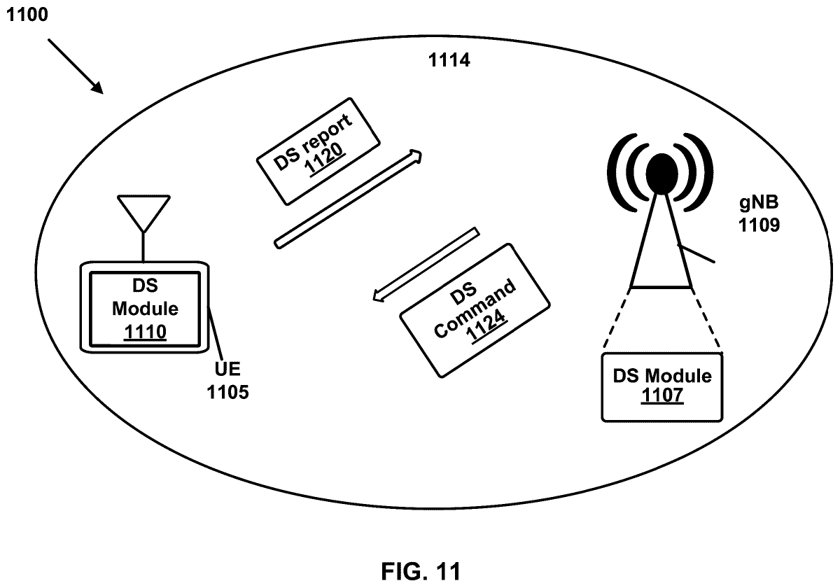

FIG. 11 shows example of a wireless system capable of uplink waveform dynamic switching (DS) according to some aspects of some of various exemplary embodiments of the present disclosure. System 1100 may include gNB 1109 and UE 1105, both engaged in UL waveform Dynamic Switching (DS) as described herein. gNB 1107 may include DS module 1107, responsible for executing dynamic waveform switching between DFT-S-OFDM and CP-OFDM waveforms and vice versa. Likewise, UE 1105 may include DS module 1105, which enables the dynamic waveform switching between DFT-S-OFDM and CP-OFDM waveforms and vice versa.

In the presented scenario, illustrated in FIG. 1, UE 1105 initiates a DS report 1120 and transmits it to the gNB 1109. Upon receipt of this report, gNB 1109 leverages the information contained within it to make a well-informed decision regarding whether UE 1105 should transition its UL waveform from CP-OFDM to DFT-S-OFDM or vice versa. This DS report may include vital data, including Power Headroom (PH), maximum UE transmit Power (Pmax) for the current waveform, Pmax for the target waveform, calculated PUSCH power, and Maximum Permissible Exposure (MPE).

The PH metric indicates the remaining transmission power available for the UE to utilize, in addition to the power already allocated to the ongoing transmission. This can be succinctly expressed using the following formula:

PH=Pmax−PUSCH Power (1)

In this formula, positive PH values denote surplus power available in relation to the maximum UE transmit power and the current UE transmit power. Conversely, negative values signify the disparity between the maximum UE transmit power and the calculated UE transmit power. When the calculated PUSCH power of a UE surpasses Pmax, resulting in a negative PH value, it signifies that the UE is experiencing coverage issues.

In some examples, DS report 1120 may include physical characteristics of the current waveform, and the target waveform including, physical characteristics of the first waveform and the second waveform include PH, Pmax, maximum permissible exposure (MPE), signal-to-noise ratio (SNR), transmit power control (TPC), and ACK/NCK, etc.

gNB transmits DS command 1124 to UE 1105, instructing it to transition current UL waveform to a target waveform. In some examples, DS command 1124 may include Frequency Domain Resources Allocation (FDRA) and Modulation and Coding Scheme (MCS) of the target waveform.

In some examples, gNB 1109 may instruct transitioning UE 1105 to a different waveform for a predetermined duration, and once it receives the target waveform report DS 1120, it can determine if the target waveform enhance the coverage or throughput. In addition, gNB 1109 can assess the received Signal-to-Noise-Ratio (SNR) for the target waveform to ascertain whether any improvement has been realized. In another variant, gNB 1109 may take into account SNR measurements associated with TPC command to augment power, and if the receive SNR cannot be further improved, it may opt to transition UE 1105 to a different waveform. In an alternative approach, gNB 1109 may take into account ACK/NCK feedback to initiate to transition the UE 1105 to a different waveform.

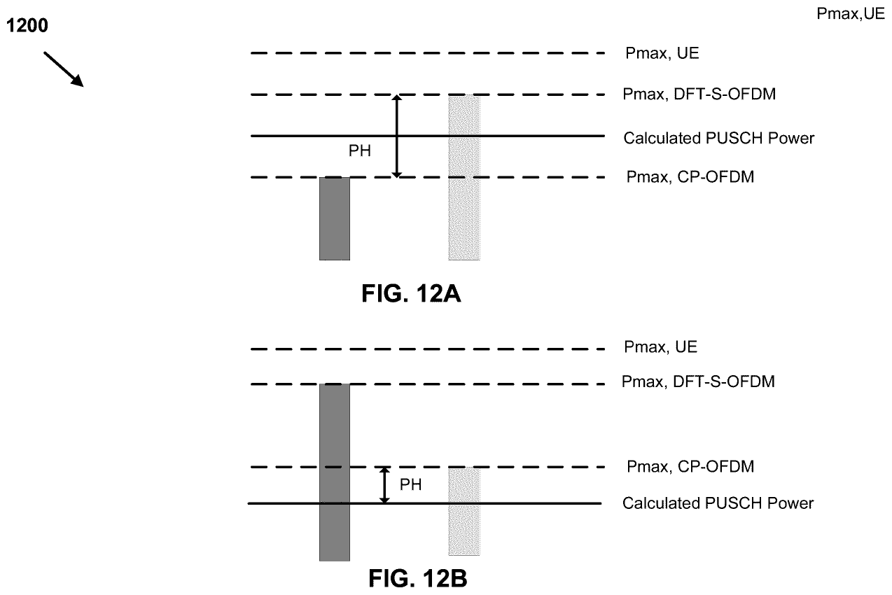

FIG. 12A shows example diagrams illustrating switching from CP-OFDM to DFT-S-OFDM according to some aspects of some of various exemplary embodiments of the present disclosure. FIG. 12B shows example diagrams illustrating switching from DFT-S-OFDM to CP-OFDM according to some aspects of some of various exemplary embodiments of the present disclosure.

As shown in FIG. 12A, As shown in FIG. 2, the UL waveform is transitioning from CP-OFDM to DFT-S-OFDMA. When the UE is configured with CP-OFDM, and the gNB lacks information about the PH for the target waveform, DFT-S-OFDM, it remains unaware of the extent to which the UE can increase its PH. Consequently, switching to DFT-S-OFDM may not guarantee an enhancement in coverage.

As depicted, the UE reports its (PH, thereby providing the gNB with information about the available PH and the power increment associated with transitioning the UE to DFT-S-OFDM. The UE is capable of computing the required PUSCH power for the UL transmission, enabling it to assess the potential benefits of switching to DFT-S-OFDM. In certain variations, the UE may communicate a recommendation to the gNB, which the gNB may take into consideration or disregard.

Furthermore, the gNB can calculate the desired PUSCH power based on pathloss and decide whether to transition the UE to DFT-S-OFDM or maintain the current waveform. In the illustrated example in FIG. 12A, the calculated PUSCH power is lower than Pmax, DFT-S-OFDM, indicating that transitioning the UE to DFT-S-OFDM has the potential to increase PH, consequently enhancing coverage.

FIG. 12B depicts the UL waveform transition from DFT-S-OFDMA to CP-OFDM. In scenarios where the calculated PH is significant, and the UE is currently configured with DFT-S-OFDM, the gNB may consider switching the UE to CP-OFDM. However, the lack of PH information regarding the target waveform poses a challenge for the efficient planning of Frequency Domain Resource Allocation (FDRA). Consequently, it becomes imperative for the UE to report its PH, Pmax, and Maximum Permissible Exposure (MPE) to the gNB.

As demonstrated in FIG. 12B, when the UE is currently configured with DFT-S-OFDM, transitioning the UL waveform to CP-OFDM has the potential to decrease PH. However, it's important to note that the calculated PUSCH power remains below the maximum allowable limit, Pmax, CP-OFDM. In such a scenario, the gNB may issue an instruction for the UE to switch to CP-OFDM, aiming to enhance its throughput.

It is important to note that DFT-S-OFDM is specifically utilized for single-layer PUSCH transmission, while CP-OFDM serves as the preferred modulation scheme for multi-layer PUSCH transmission.

In cases where a UE is initially configured with single-layer CP-OFDM and encounters coverage issues, the gNB may decide to transition the UE to DFT-S-OFDMA while maintaining the same number of layers as CP-OFDM. However, it's crucial to note that if the UE is configured with multi-layer CP-OFDM and is facing coverage problems, switching to single-layer DFT-S-OFDM may resolve the PH issue but could potentially lead to a reduction in throughput. This reduction occurs due to the transition from a multi-layer PUSCH configuration to a single-layer PUSCH configuration.

Therefore, the gNB must meticulously evaluate the FDRA and Modulation and Coding Scheme (MCS) of the target waveform in addition to the PH, Pmax, and MPE of the target waveform before initiating the switch. This assessment ensures that the transition aligns with the specific requirements of the target waveform and effectively enhances network performance.

In one approach, the gNB may calculate the channel throughput for both UL waveforms and make the switching decision based on this evaluation. In an alternative approach, the decision to transition the UE's UL transmission to an alternative waveform may involve a combination of factors, including MPE and the power spectral density (PSD) of the waveforms. By considering these factors, the gNB can make an informed choice regarding the UL waveform switch, taking into account both coverage and throughput optimization.

In certain scenarios, the gNB possesses the capability to initiate UL waveform switching by assessing a PH threshold. When the PH of the current UL waveform drops below this threshold, the gNB may decide to transition the UL Physical Uplink Shared Channel (PUSCH) to an alternative waveform.

Alternatively, the decision to switch UL waveforms can be influenced by Signal-to-Noise Ratio (SNR) measurements derived from Demodulation Reference Signal (DMRS). If the measured SNR for the current Frequency FDRA, MCS, and pathloss falls below a specified threshold, the gNB may choose to transition the UE to an alternative waveform.

In certain examples, the decision to switch UL waveforms may involve a comparison of at least one physical characteristic between the current waveform and the target waveform. These physical characteristics encompass power headroom (PH), maximum transmit power (Pmax), maximum permissible exposure (MPE), signal-to-noise ratio (SNR), transmit power control (TPC), and ACK/NCK (Acknowledgment/Negative Acknowledgment), etc.

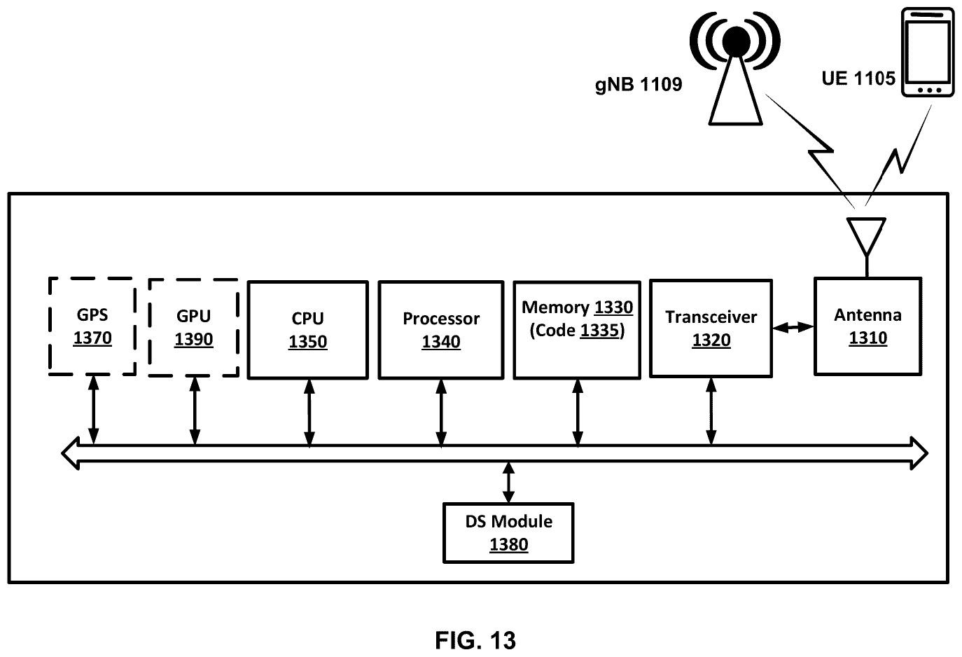

FIG. 13 shows example components of a user equipment 1105 and a gNB 1109 for transmission and/or reception according to some aspects of some of various exemplary embodiments of the present disclosure. All or a subset of blocks and functions in FIG. 13 may be in the gNB 1109 and the user equipment 1105 and may be performed by the user equipment 1105 and by the base station 1109. The Antenna 1310 may be used for transmission or reception of electromagnetic signals. The Antenna 1310 may comprise one or more antenna elements and may enable different input-output antenna configurations including Multiple-Input Multiple Output (MIMO) configuration, Multiple-Input Single-Output (MISO) configuration and Single-Input Multiple-Output (SIMO) configuration. In some embodiments, the Antenna 1310 may enable a massive MIMO configuration with tens or hundreds of antenna elements. The Antenna 1310 may enable other multi-antenna techniques such as beamforming. In some examples and depending on the UE 1105 capabilities or the type of UE 1105 (e.g., a low-complexity UE), the UE 1105 may support a single antenna only.

The transceiver 1320 may communicate bi-directionally, via the Antenna 1310, wireless links as described herein. For example, the transceiver 1320 may represent a wireless transceiver at the UE and may communicate bi-directionally with the wireless transceiver at the base station or vice versa. The transceiver 1320 may include a modem to modulate the packets and provide the modulated packets to the Antennas 1310 for transmission, and to demodulate packets received from the Antennas 1310.

The memory 1330 may include RAM and ROM. The memory 1330 may store computer-readable, computer-executable code 1335 including instructions that, when executed, cause the processor to perform various functions described herein. In some examples, the memory 1330 may contain, among other things, a Basic Input/output System (BIOS) which may control basic hardware or software operation such as the interaction with peripheral components or devices.

The processor 1340 may include a hardware device with processing capability (e.g., a general purpose processor, a DSP, a CPU, a microcontroller, an ASIC, an FPGA, a programmable logic device, a discrete gate or transistor logic component, a discrete hardware component, or any combination thereof). In some examples, the processor 1340 may be configured to operate a memory using a memory controller. In other examples, a memory controller may be integrated into the processor 1340. The processor 1340 may be configured to execute computer-readable instructions stored in a memory (e.g., the memory 1330) to cause the UE 1300 or the base station 1305 to perform various functions.

The Central Processing Unit (CPU) 1350 may perform basic arithmetic, logic, controlling, and Input/output (I/O) operations specified by the computer instructions in the Memory 1330. The user equipment 1300 and/or the base station 1305 may include additional peripheral components such as a graphics processing unit (GPU) 1360 and a Global Positioning System (GPS) 1370. The GPU 1360 is a specialized circuitry for rapid manipulation and altering of the Memory 1330 for accelerating the processing performance of the user equipment 1105 and/or the gNB 1109. The GPS 1370 may be used for enabling location-based services or other services, for example based on geographical position of the user equipment 1105.

The DS module 1380 includes DS module 1110 of UE 1105 or DS module 1107 of gNB 1109 with reference to FIG. 11. DS module 1380 performs DS waveform switching and reporting according to some aspects of some of various exemplary embodiments of the present disclosure. In the gNB, 1109, module 1380 receives DS report from UE, measures UL current waveform physical characteristics, determine the target waveform physical characteristics, and determine whether switching to the target waveform is required, and transmits instructions to transition the UE to the target waveform or not. In the UE, module 1380 measures and/or determines UL waveform physical characteristics, and provide DS report to the gNB.

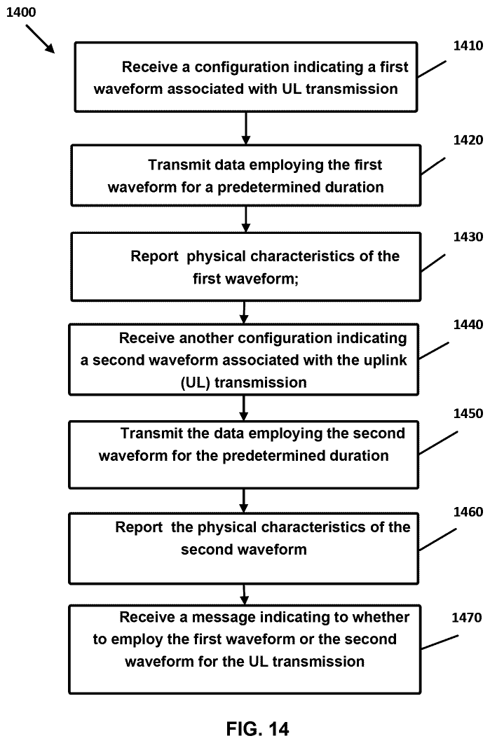

FIG. 14 shows an example of a method performed by a UE to perform dynamic waveform switching according to some aspects of some of various exemplary embodiments of the present disclosure.

At step 1410, the UE receives a configuration, transmitted from a gNB indicating the use of a first waveform for uplink (UL) transmission. The configuration may include the DS command from the gNB to switch the current UE UL waveform to a target waveform. The first waveform may include CP-OFDM or DFT-S-OFDM.

In some examples, the UE may receive configuration via Downlink Control Information (DCI), utilizing dedicated bits for DS switching between different waveforms.

At step 1420, the UE transmits to the gNB data employing the first waveform for a predetermined duration. The predetermined duration may be transmitted in the configuration message received from the gNB.

At step 1430, the UE reports physical characteristics of the first waveform. In some examples, the physical characteristics of the first waveform may include (PH), maximum transmit power (Pmax), maximum permissible exposure (MPE), signal-to-noise ratio (SNR), transmit power control (TPC), and ACK/NCK, etc.

At step 1440, the UE receives another configuration indicating a second waveform associated with the uplink (UL) transmission. Another configuration may include the DS command from the gNB to switch the current UE UL waveform to a target waveform. The second waveform may include CP-OFDM or DFT-S-OFDM.

At step 1450, the UE transmits to the BS the data employing the second waveform for the predetermined duration. The predetermined duration may be transmitted in another configuration message received from the gNB.

At step 1460, the UE reports to the BS the physical characteristics of the second waveform. In some examples, the physical characteristics of the second waveform may include PH, Pmax, MPE, SNR, TPC, and ACK/NCK, etc.

At step 1470, the UE receives a message from the BS indicating to whether to employ the first waveform or the second waveform for the UL transmission.

In certain scenarios, the UE has the capability to determine its preferred waveform based on the calculated physical characteristics of the first and second waveforms. It can then report its preference to the gNB. The gNB may take the UE's recommendation into consideration, although it reserves the right to make the final decision.

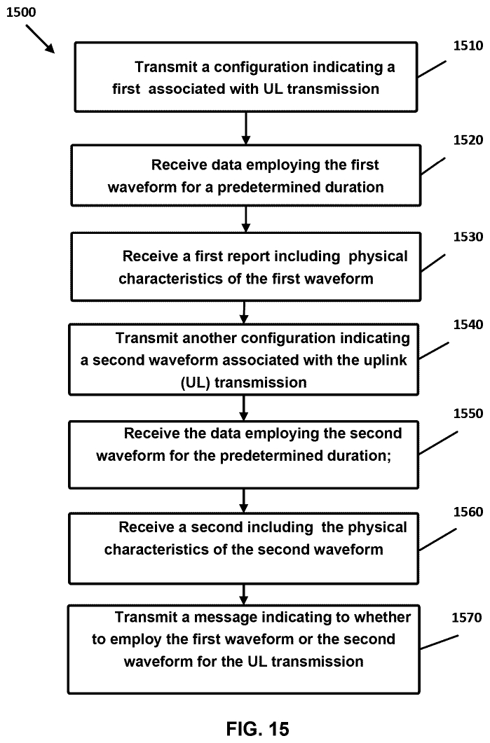

FIG. 15 shows an example of a method performed by a gNB to perform dynamic waveform switching according to some aspects of some of various exemplary embodiments of the present disclosure.

At step 1510 a gNB transmits, to a user equipment (UE), a configuration indicating a first waveform associated with uplink (UL) transmission. The configuration may include the DS command from the gNB to switch the current UE UL waveform to a target waveform. The first waveform may include CP-OFDM or DFT-S-OFDM.

In some examples, the gNB may transmit configuration via Downlink Control Information (DCI), utilizing dedicated bits for DS switching between different waveforms.

At step 1520, the gNB receives, from the UE, data on the first waveform for a predetermined duration. The predetermined duration may be transmitted in the configuration message received to the UE.

At step 1530, the gNB receives a first report, from the UE, including physical characteristics of the first waveform. In some examples, the physical characteristics of the first waveform may include (PH), maximum transmit power (Pmax), maximum permissible exposure (MPE), signal-to-noise ratio (SNR), transmit power control (TPC), and ACK/NCK, etc.

At step 1540, the gNB transmits, to the UE, another configuration indicating a second waveform associated with the uplink (UL) transmission. Another configuration may include the DS command from the gNB to switch the current UE UL waveform to a target waveform. The second waveform may include CP-OFDM or DFT-S-OFDM.

At step 1550, the UE receives, from the UE, the data employing the second waveform for the predetermined duration. The predetermined duration may be transmitted in another configuration message to the UE.

At step 1560, the gNB receives a second report, from the UE, including the physical characteristics of the second waveform. In some examples, the physical characteristics of the second waveform may include PH, Pmax, MPE, SNR, TPC, and ACK/NCK, etc.

At step 1570, the gNB transmits a message to the UE, indicating whether to employ the first waveform or the second waveform for the UL transmission.

In certain scenarios, the gNB may receive the UE's preferred waveform. However, it can take the UE's recommendation into consideration, although it reserves the right to make the final decision.

The exemplary blocks and modules described in this disclosure with respect to the various example embodiments may be implemented or performed with a general-purpose processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. Examples of the general-purpose processor include but are not limited to a microprocessor, any conventional processor, a controller, a microcontroller, or a state machine. In some examples, a processor may be implemented using a combination of devices (e.g., a combination of a DSP and a microprocessor, multiple microprocessors, one or more microprocessors in conjunction with a DSP core, or any other such configuration).

The functions described in this disclosure may be implemented in hardware, software executed by a processor, firmware, or any combination thereof. Instructions or code may be stored or transmitted on a computer-readable medium for implementation of the functions. Other examples for implementation of the functions disclosed herein are also within the scope of this disclosure. Implementation of the functions may be via physically co-located or distributed elements (e.g., at various positions), including being distributed such that portions of functions are implemented at different physical locations.

Computer-readable media includes but is not limited to non-transitory computer storage media. A non-transitory storage medium may be accessed by a general purpose or special purpose computer. Examples of non-transitory storage media include, but are not limited to, random access memory (RAM), read-only memory (ROM), electrically erasable programmable ROM (EEPROM), flash memory, compact disk (CD) ROM or other optical disk storage, magnetic disk storage or other magnetic storage devices, etc. A non-transitory medium may be used to carry or store desired program code means (e.g., instructions and/or data structures) and may be accessed by a general-purpose or special-purpose computer, or a general-purpose or special-purpose processor. In some examples, the software/program code may be transmitted from a remote source (e.g., a website, a server, etc.) using a coaxial cable, fiber optic cable, twisted pair, digital subscriber line (DSL), or wireless technologies such as infrared, radio, and microwave. In such examples, the coaxial cable, fiber optic cable, twisted pair, DSL, or wireless technologies such as infrared, radio, and microwave are within the scope of the definition of medium. Combinations of the above examples are also within the scope of computer-readable media.

As used in this disclosure, use of the term “or” in a list of items indicates an inclusive list. The list of items may be prefaced by a phrase such as “at least one of” or “one or more of”. For example, a list of at least one of A, B, or C includes A or B or C or AB (i.e., A and B) or AC or BC or ABC (i.e., A and B and C). Also, as used in this disclosure, prefacing a list of conditions with the phrase “based on” shall not be construed as “based only on” the set of conditions and rather shall be construed as “based at least in part on” the set of conditions. For example, an outcome described as “based on condition A” may be based on both a condition A and a condition B without departing from the scope of this disclosure.

In this specification the terms “comprise”, “include” or “contain” may be used interchangeably and have the same meaning and are to be construed as inclusive and open ending. The terms “comprise”, “include” or “contain” may be used before a list of elements and indicate that at least all of the listed elements within the list exist but other elements that are not in the list may also be present. For example, if A comprises B and C, both {B, C} and {B, C, D} are within the scope of A.

The present disclosure, in connection with the accompanied drawings, describes example configurations that are not representative of all the examples that may be implemented or all configurations that are within the scope of this disclosure. The term “exemplary” should not be construed as “preferred” or “advantageous compared to other examples” but rather “an illustration, an instance or an example.” By reading this disclosure, including the description of the embodiments and the drawings, it will be appreciated by a person of ordinary skills in the art that the technology disclosed herein may be implemented using alternative embodiments. The person of ordinary skill in the art would appreciate that the embodiments, or certain features of the embodiments described herein, may be combined to arrive at yet other embodiments for practicing the technology described in the present disclosure. Thus, the disclosure is not limited to the examples and designs described herein but is to be accorded the broadest scope consistent with the principles and novel features disclosed herein.

1. A method for optimizing wireless communication in a cellular network, performed by a user equipment (UE), the method comprising the steps of:
receiving, from a base station (BS), a configuration indicating a first waveform associated with uplink (UL) transmission;
transmitting, to the BS, data employing the first waveform for a predetermined duration;
reporting, to the BS, physical characteristics of the first waveform;
receiving, from the BS, another configuration indicating a second waveform associated with the uplink (UL) transmission;
transmitting, to the BS, the data employing the second waveform for the predetermined duration;
reporting, to the BS, the physical characteristics of the second waveform; and
receiving a message, from the BS, indicating to whether to employ the first waveform or the second waveform for the UL transmission.

2. The method of claim 1, wherein:
the first waveform includes a discrete Fourier transform spread orthogonal frequency division multiplexing (DFT-S-OFDM) waveform configured for a single transmission layer transmission; and
the second waveform includes cyclic prefix frequency division multiplexing (CP-OFDM) waveform configured for a single transmission layer or multiple transmission layers.

3. The method of claim 1, wherein the physical characteristics of the first waveform and of the second waveform include power headroom (PH), maximum transmit power (Pmax), maximum permissible exposure (MPE), signal-to-noise ratio (SNR), transmit power control (TPC) and acknowledge/negative acknowledge (ACK/NCK).

4. The method of claim 1, wherein the message includes the frequency domain resource allocation, and modulation and coding scheme (MCS) of the first or the second waveform.

5. The method of claim 1, further comprising:
determining a preferred waveform between the first waveform and the second waveform based on the physical characteristics of the first waveform and the physical characteristics of the second waveform; and
reporting the preferred waveform to the base station (BS).

6. The method of claim 1, further comprising:
receiving an indication, from the base station (BS), to switch from the first waveform to the second waveform; or
receiving an indication, from the BS, to switch from the second waveform to the first waveform.

7. A method for optimizing wireless communication in a cellular network, performed by a base station (BS), the method comprising the steps of:
transmitting, to a user equipment (UE), a configuration indicating a first waveform associated with uplink (UL) transmission;
receiving, from the UE, data on the first waveform for a predetermined duration;
receiving a first report, from the UE, including physical characteristics of the first waveform;
transmitting, to the UE, another configuration indicating a second waveform associated with the uplink (UL) transmission;
receiving, from the UE, the data employing the second waveform for the predetermined duration;
receiving a second report, from the UE, including the physical characteristics of the second waveform; and
transmitting a message to the UE indicating whether to employ the first waveform or the second waveform for the UL transmission.

8. The method of claim 7, wherein:
the first waveform includes a discrete Fourier transform spread orthogonal frequency division multiplexing (DFT-S-OFDM) waveform configured for a single transmission layer transmission; and
the second waveform includes cyclic prefix frequency division multiplexing (CP-OFDM) waveform configured for a single transmission layer or multiple transmission layers.

9. The method of claim 1, wherein:
the first report includes power headroom (PH), maximum transmit power (Pmax), maximum permissible exposure (MPE), signal-to-noise ratio (SNR), transmit power control (TPC) and ACK/NCK of the first waveform; and
the second report include power headroom (PH), maximum transmit power (Pmax), maximum permissible exposure (MPE), signal-to-noise ratio (SNR), transmit power control (TPC), and ACK/NCK of the second waveform.

10. The method of claim 1, further comprising:
determining the first waveform or the second waveform for the uplink (UL) transmission based on the received first report and the second report.

11. The method of claim 10, wherein the determining includes considering frequency domain resource allocation, and modulation and coding scheme (MCS) of the first or the second waveform.

12. The method of claim 10, wherein the determining includes:
computing the uplink (UL) throughput employing the first waveform;
computing the UL throughput employing the second waveform;
comparing the computed UL throughput of the first waveform and the second waveform; and
indicating, to the UE, to employ the first waveform whether computed throughput of the first waveform is greater than the computed throughput of the second waveform; or
indicating, to the UE, to employ the second waveform whether computed throughput of the second waveform is greater or equal than the computed throughput of the second waveform.

13. The method of claim 10, wherein the determining is based on comparing at least one of physical characteristic of the first waveform and the second waveform, and wherein the physical characteristics include:
power headroom (PH), maximum transmit power (Pmax), maximum permissible exposure (MPE), signal-to-noise ratio (SNR), transmit power control (TPC) and ACK/NCK.

14. The method of claim 7, further comprising:
determining to switch from the first waveform to the second waveform, or to switch from the second waveform to the first waveform;
transmitting an indication, to the user equipment (UE), to switch from the first waveform to the second waveform; or
transmitting an indication, to the UE, to switch from the second waveform to the first waveform.

15. The method of claim 14, wherein the switching includes:
considering frequency domain resource allocation, and modulation and coding scheme (MCS) of the first or the second waveform.

16. The method of claim 14, wherein the determining includes:
comparing one or more physical characteristics of the first waveform with associated thresholds; or
comparing one or more physical characteristics of the second waveform with associated threshold.

17. The method of claim 14, wherein the physical characteristics of the first waveform and the second waveform include power headroom (PH), maximum transmit power (Pmax), maximum permissible exposure (MPE), signal-to-noise ratio (SNR), transmit power control (TPC), and ACK/NCK.

18. The method of claim 17, wherein:
the base station (BS) determines to switch from the first waveform to the second waveform if power headroom (PH) of the first waveform falls below a threshold; or
the base station (BS) determines to switch from the second waveform to the first waveform if the PH of the second waveform falls below a threshold.

19. A base station (BS), comprising
a transceiver configured to:
transmit, to a user equipment (UE), a configuration indicating a first waveform associated with uplink (UL) transmission;
receive, from the UE, data on the first waveform for a predetermined duration;
receive a first report, from the UE, including physical characteristics of the first waveform;
transmit to the UE, another configuration indicating a second waveform associated with the uplink (UL) transmission;
receive, from the UE, the data employing the second waveform for the predetermined duration;
receive a second report, from the UE, including the physical characteristics of the second waveform; and
transmit a message to the UE, indicating whether to employ the first waveform or the second waveform for the UL transmission.

20. The base station (BS) of claim 19, further comprising:
a processor configured to:
determining the first waveform or the second waveform for the uplink (UL) transmission based on the received first report and the second report.
